(19) United States
(12) Patent Application Publication
(10) Pub. No.: US 2025/0322662 A1
(43) Pub. Date: Oct. 16, 2025

(54) SYSTEMS AND METHODS FOR ADVANCED HOME SYSTEMS

(71) Applicant: CSAA Insurance Services, Inc., Walnut Creek, CA (US)

(72) Inventors: Anthony Duer, Concord, CA (US); Beti Cung, Walnut Creek (CA)

(21) Appl. No.: 19/170,433

(22) Filed: Apr. 4, 2025

Related U.S. Application Data
(60) Provisional application No. 63/634,705, filed on Apr. 16, 2024.

(51) Int. Cl. G06V 20/50; G06N 20/00; G06V 10/75; G06V 10/764; G06V 10/774; G06V 10/82; G06V 20/40

(52) U.S. Cl. CPC G06V 20/50; G06N 20/00; G06V 10/751; G06V 10/764; G06V 10/82; G06V 20/41; G06V 10/774

(57) ABSTRACT

In one aspect, an example method includes: (a) capturing a plurality of images of a home environment; (b) receiving a user input, wherein the user input is associated with the captured plurality of images of the home environment; (c) generating a home recommendation model using one or more machine learning models, wherein the one or more machine learning models are configured to generate the home recommendation model using the captured plurality of images of the home environment and the received user input; (d) identifying one or more home recommendations, wherein the one or more home recommendations are based on at least the generated home recommendation model; and (e) transmitting instructions that cause a computing device to display, via a user interface of the computing device, a graphical indication of the one or more home recommendations.

### RELATED APPLICATION

This application claims priority to U.S. Provisional Application No. 63/634,705, filed on Apr. 16, 2024, which is incorporated herein by reference in its entirety.

### USAGE AND TERMINOLOGY

In this disclosure, unless otherwise specified and/or unless the particular context clearly dictates otherwise, the terms “a” or “an” mean at least one, and the term “the” means the at least one.

### SUMMARY

In one aspect, an example computing system for generating home recommendations is disclosed. The example computing system comprises a mobile device comprising a camera, a graphical user interface, and a non-transitory computer-readable medium, having stored thereon program instructions that, upon execution by the one or more processors, cause the mobile computing device to perform a set of operations comprising: (a) capturing, via the camera of the mobile computing device, a plurality of images of a home environment; and (b) receiving, via the user interface of the mobile computing device, a user input, wherein the user input is associated with the captured plurality of images of the home environment. The example computing system further comprises a modeling computing device, wherein the modeling computing device comprises a processor and a non-transitory computer-readable medium, having stored thereon program instructions that, upon execution by the processor, cause the modeling computing device to perform a set of operations comprising: (a) receiving, from the mobile computing device, the captured plurality of images of the home environment and the received user input; (b) generating a home recommendation model using one or more machine learning models, wherein the one or more machine learning models are configured to generate the home recommendation model using the captured plurality of images of the home environment and the received user input; (c) identifying one or more home recommendations, wherein the one or more home recommendations are based on at least the generated home recommendation model; and (d) transmitting, to the mobile computing device, instructions that cause the mobile computing device to display, via the user interface of the mobile computing device, a graphical indication of the one or more home recommendations.

In another aspect, an example non-transitory computer-readable medium, having stored thereon program instructions that, upon execution by the one or more processors, cause a computing system to perform a set of operations is disclosed. In examples, the set of operations comprise: (a) capturing a plurality of images of a home environment; (b) receiving a user input, wherein the user input is associated with the captured plurality of images of the home environment; (c) generating a home recommendation model using one or more machine learning models, wherein the one or more machine learning models are configured to generate the home recommendation model using the captured plurality of images of the home environment and the received user input; (d) identifying one or more home recommendations, wherein the one or more home recommendations are based on at least the generated home recommendation model; and (e) transmitting instructions that cause a computing device to display, via a user interface of the computing device, a graphical indication of the one or more home recommendations.

In another aspect, an example method is disclosed. The method includes (a) capturing a plurality of images of a home environment; (b) receiving a user input, wherein the user input is associated with the captured plurality of images of the home environment; (c) generating a home recommendation model using one or more machine learning models, wherein the one or more machine learning models are configured to generate the home recommendation model using the captured plurality of images of the home environment and the received user input; (d) identifying one or more home recommendations, wherein the one or more home recommendations are based on at least the generated home recommendation model; and (e) transmitting instructions that cause a computing device to display, via a user interface of the computing device, a graphical indication of the one or more home recommendations.

### BRIEF DESCRIPTION OF THE DRAWINGS

FIG. 1 is a simplified block diagram of an example computing device.

FIG. 2 is an example home recommendation computing system.

FIG. 3A is an example mobile computing device of a home recommendation computing system and graphical user interface in a first state.

FIG. 3B is the example mobile device of the home recommendation computing system and graphical user interface of FIG. 3A, but in a second state.

FIG. 3C is the example mobile device of the home recommendation computing system and graphical user interface of FIGS. 3A-3B, but in a third state.

FIG. 3D is the example mobile device of the home recommendation computing system and graphical user interface of FIGS. 3A-3C, but in a fourth state.

FIG. 3E is the example mobile device of the home recommendation computing system and graphical user interface of FIGS. 3A-3D, but in a fifth state.

FIG. 3F is the example mobile device of the home recommendation computing system and graphical user interface of FIGS. 3A-3E, but in a sixth state.

FIG. 3G is the example mobile device of the home recommendation

computing system and graphical user interface of FIGS. 3A-3F, but in a seventh state.

FIG. 4A is an example mobile computing device of a home recommendation computing system and graphical user interface in a first state.

FIG. 4B is the example mobile device of the home recommendation computing system and graphical user interface of FIG. 4A, but in a second state.

FIG. 4C is the example mobile device of the home recommendation computing system and graphical user interface of FIGS. 4A-4B, but in a third state.

FIG. 4D is the example mobile device of the home recommendation computing system and graphical user interface of FIGS. 4A-4C, but in a fourth state.

FIG. 5A is an example mobile computing device of a home recommendation computing system and graphical user interface in a first state.

FIG. 5B is the example mobile device of the home recommendation computing system and graphical user interface of FIG. 5A, but in a second state.

FIG. 6 is a flow chart of an example method.

### DETAILED DESCRIPTION

### I. Overview

When looking to purchase and/or improve (e.g., remodel) a home, a user may have to sift through hundreds of listings, tours, and/or remodeling options before finding a preferred home. For example, to a home buyer, two homes may have the exact same number of bedrooms, bathrooms, amenities, etc. but only one will feel like home. The decision to buy and/or remodel a home is often emotional, visual (qualitative) purchasing decision, not just about square footage or number of bedrooms and bathrooms (quantitative). Further, current virtual home listings and remodeling options are limited, and may not include the qualitative or quantitative fixtures that are important to a home buyer and/or remodeler, or allow the home buyer and/or remodeler to meaningfully interact with or refine the displayed results. For instance, photos allow the potential buyer and/or remodeler to only view what the listing photographer captured and 360° cameras only allow viewing from a fixed point in space. These limitations prohibit potential buyers and/or remodelers from looking at features that they may find personally important to them, such as if there are electrical outlets on the kitchen island unable to be seen in either of these two conventional home listing methods. Generally, once the home buyer purchases and/or remodels the home, his or her interaction with improving the home (e.g., improving the safety of the home) are similarly limited—particularly when interacting with entities that may assist the home buyer in improving the home (e.g., renovators, insurance companies, etc.).

If, however, the home-buying and/or home-improving systems and associated models could provide an efficient, effective, and novel solution for qualitatively and quantitatively searching active home listings simultaneously, and then rendering an online viewing method in which a user could explore a 3D model to check for their subjective interests, the home-buying and/or remodeling experience would be much improved. By allowing potential buyers and/or remodelers full freedom of movement through the listed home and/or virtual renderings of an existing home without needing to download bulky 3D object and texture data, such as by utilizing neural networks that can compress 3D scenes into very small models, a website can allow for a full, photo realistic 3D scene to be downloaded quickly via browser and then presented to the potential buyer and/or remodeler.

Accordingly, features of the present disclosure can help to address these and other issues to provide an improvement to select technical fields. More specifically, features of the present disclosure help address issues within and provide improvements for select technical fields, which include for example, operating one or more machine learning models in tandem to allow users to visually describe their perfect home and then find the closest match in available listings, while still respecting other quantitative parameters. For instance, in one scenario, a user may enter a text description of a house and have the machine generate an image representative of that home. In another, a user could provide a simplistic drawing of their idealized home and the machine could take care of filling in the missing details to generate a lifelike version of that home. This would reduce the potential buyer and/or remodeler's mental load and reduces the time it takes to find a home that matches what the buyer and/or remodeler is truly interested in. Further, once appropriate listings are narrowed down, one or more machine learning models may be used that allows for high fidelity, dynamic scenes to be reconstructed using short video clips or individual images, allowing the potential home buyer to view the available, narrowed down list of properties from arbitrary viewpoints without having to travel to the home in person for viewing. Further, one or more remodeling options may be presented to a user in the same or similar manner. By promoting homes that match more closely to a potential buyer and/or remodeler's wants, both the potential buyer and/or remodeler, and the seller and/or contractors, alike, benefit from this home discovery process and are more likely to complete a sale and/or remodel.

More specifically, example embodiments relate to methods, systems, and devices that allow a home recommendation computing system to provide improved home improvement and/or home purchasing decisions by leveraging one or more camera technologies (e.g., a short video of a portion of the home taken by a mobile computing device) and other data associated with the home (e.g., video and/or image data of one or more homes that are similar to the home, etc.).

To facilitate this analysis, the home recommendation computing system may use one or more components to carry out various steps of this process. For example, the home recommendation computing system may include a mobile computing device (e.g., a smartphone associated with a potential home buyer and/or owner seeing to remodel a home) and a modeling computing device (e.g., a cloud-based computing device that receives data from a number of sources and uses a machine learning model to create one or more models based on the received data). These computing devices can be used to perform various operational functions within the home recommendation computing system to determine and display various attributes associated with a home, as well as further actions that should be undertaken by the home buyer and/or owner, as well as a related entity (e.g., an insurance company).

In one aspect, the mobile computing device of the home recommendation computing system may be used to collect information in connection with a home. In some examples, this information may include one or more images and/or videos of the home (e.g., using a camera of the mobile computing device), user input data (e.g., from a user of the mobile computing device), and/or location data (e.g., using a GPS sensors of the mobile computing device), among other types of information. In some examples, this information may be collected and verified as pertaining to one or more particular portions of the home. For example, if the user of the mobile computing device wants to capture a plurality of images of a portion of the home (e.g., an exterior portion of the home) and input one or more requests for recommendations for the home (e.g., a request to receive listing information for the home and/or homes that similar to the home, a request on how to improve the safety of the exterior portion of the home, etc.), then the mobile computing device may be used to capture the one or more images of the portion of the home and one or more additional sensors of the mobile computing device may be used to supplement and/or verify the captured images and/or the user input (e.g., using GPS data for the mobile computing device when the images are captured). Other examples are possible.

For example, when this information includes one or more images and/or videos captured of the home using a camera of the mobile computing device, these images and/or videos may be captured from different angles by the camera of the mobile computing device in relation to the home environment and/or portions thereof. For example, if the user of the mobile computing device wants to capture a plurality of images of an interior portion of the home (e.g., different angles and/or different portions of a kitchen) and input one or more requests for recommendations for the interior portion of the home (e.g., a request to receive listing information for homes that have a similar kitchen to the home, a request on how to improve the safety of the kitchen of the home, etc.), then the mobile computing device may be used to capture the one or more images of the interior portion of the home from different angles to ensure that the images of the interior portion accurately reflect the environment that the user is seeking to use gain more information and/or use as a proper comparator for recommendations. Other examples are possible.

In some examples, this information may include user input information collected by the mobile computing device (e.g., via a graphical user interface and/or keyboard of the mobile computing device) pertaining to one or more particular portions of the home. For example, this user input may include text-based information relating to a home recommendation request (e.g., in connection with the captured plurality of images of the home). For example, in some embodiments, this text-based information may include one or more of: (i) a request to receive listing information for a home that is in the captured plurality of images; (ii) a request to receive listing information for one or more homes that are similar to the home in the captured plurality of images; (iii) a request to receive listing information for one or more homes that match and/or have one or more similar features to a description of a home inputted by the user of the mobile computing device; in the captured plurality of images; and (iv) a request to receive one or more recommendations (e.g., safety recommendations, home improvement recommendations, etc.) for the home that is in the captured plurality of images, among other possibilities.

For example, the user input may include one or more annotations of information relating to a home recommendation request (e.g., annotations of the captured plurality of images of the home). For example, in some embodiments, this annotation information may include one or more of: (i) a request to receive listing information for a home that is annotated in the captured plurality of images (e.g., if the user circles a particular home in plurality of images of multiple homes); (ii) a request to receive listing information for one or more homes that are similar to the home that is annotated in the captured plurality of images (e.g., if the user crosses out a particular feature of a home in plurality of images; (iii) a request to receive listing information for one or more homes that match and/or have one or more similar features to a drawing inputted by the user of the mobile computing device in the captured plurality of images; and (iv) a request to receive one or more recommendations (e.g., safety recommendations, home improvement recommendations, etc.) for a home and/or feature of a home that is annotated in the captured plurality of images, among other possibilities. In a further aspect, these annotations may be inputted by the user via the user interface of the mobile computing device and/or an external device connected to the mobile computing device, among other possibilities.

In a further aspect, in example embodiments, a modeling computing device of the home recommendation computing system may collect data associated with a particular home from one or more resources. In one aspect, the modeling computing device may collect data associated with a particular home from one or more mobile computing devices associated with the particular home. In some examples, as described above, this data may include one or more images and/or videos of the particular home. In some example embodiments, these images and/or videos of the particular home may have been captured by a mobile computing device at or around the particular home and/or a location close thereto. Other examples are possible.

For example, this data for the modeling computing device may include data from public and/or private databases associated with the particular home, as well as other resources associated with the particular home (e.g., data from a real estate listing website—for example, REDFIN®, ZILLOW®, etc.). In other examples, this data may come from one or more databases and/or resources associated with the particular home (e.g. land records, government databases, etc.), geolocation and/or map data associated with the particular home, etc.). In some examples, this data may include images, videos, and other data associated with the particular home (e.g., one or more three-dimensional computing models of the particular home).

In a further aspect, in example embodiments, the modeling computing device may collect sensor data from one or more sensors on one or more homes that share attributes with the particular home (e.g., same or similar style, neighborhood, square footage, price and/or as the particular home). This sensor data may include data from one or more s as well as other resources associated with one or more homes that share one or more attributes with the particular home (e.g., data from a real estate listing website etc.). In other examples, this data may come from one or more databases and/or resources associated with one or more homes that share one or more attributes with the particular home (e.g. land records, government databases, etc.), geolocation and/or map data associated with the particular home, etc.). In some examples, this data may include images, videos, and other data associated with one or more homes that share one or more attributes with the particular home the particular home (e.g., one or more three-dimensional computing models of the particular home).

In example embodiments, once the modeling computing device collects data from various resources, the modeling computing device may also generate and maintain one or more programs to interpret this data (e.g., one or more programs securely stored on a server and/or database associated with the modeling computing device, the potential home buyer, a home owner seeking to remodel a home, and/or an associated entity—for example, an associated insurance company). For example, the modeling computing device may use one or more machine learning models to interpret this data and generate one more models based on this collected data.

For example, the modeling computing device may use image and/or video data associated with a particular home to utilize and/or train a machine learning model (e.g., Neural Radiance Fields (NeRF) model) to generate a home recommendation model that indicates a more dynamic and comprehensive representation of one or more features or environments of a home and/or the home itself. To do so, in examples, the modeling computing device may create a 3D reconstruction of the home of portions thereof based on a plurality of 2D images of the home (e.g., from a video). In this regard, NeRF models may allow high accuracy and dynamic scenes to be reconstructed using a series of images and/or short video clips. Once the initial model is generated, the model may be trained and its accuracy may be further improved by ingesting data that is associated with a particular home, including data associated with the particular home and/or more or more homes that share one or more attributes with the particular home, and/or both.

In a further aspect, in an example embodiment, the model may be trained on data associated with the particular home (e.g., a plurality of images captured of the home) and be further refined and/or trained with additional information and/or data sources (e.g., images of the particular home that are retrieved from an internet listing of the home), among other possibilities. For example, based on the data collected before the plurality of images are captured of the particular home, the modeling computing device may request that the images be collected in a specific manner. For example, the modeling computing device may request that the mobile computing device record a short video of one or more portions of the particular home at one or more relative positions, distances, and/or angles between a camera of the mobile computing device and the particular home in three-dimensional space. Other examples are possible.

In a further aspect, in an example embodiment, a party associated with the particular home (e.g., a potential purchaser) may then use a computer with a 3D application (or VR headset) to remotely view the home and/or portions thereof based on these models, and may even be able to view the home from multiple angles displayed within the reconstructed scene, thereby allowing the party to move through the virtual scene.

Utilizing these models (including NeRF models) may provide one or more distinct benefits to the home recommendation computing system, including that, rather than creating a generalized model that can be applied to any scene, these models can be trained on one scene only, which removes the requirement for large training datasets and, instead, allows a single video to train the model. Additionally, because the data required to accurately train and utilize one or more particular models (e.g., a NeRF model using, for example, color (RGB), Angle, and Depth) to reproduce a particular scene is small compared to traditional 3D models, objects, and textures, the methods and systems detailed herein can be utilized by any number of typical computing devices, including mobile computing devices (e.g., smartphones, laptop computing devices, etc.). Furthermore, although the NeRF model has been detailed herein, it should be readily apparent to those of ordinary skill in the art that other machine learning models may be used in the example embodiments detailed herein.

For example, the NeRF model may be used in addition to or alternatively from simultaneous localization and mapping (SLAM) and/or structure-from-motion (SfM) machine learning models, among other possibilities.

Once the models are trained, in example embodiments, the modeling computing device may identify one or more home recommendations (e.g., a purchasing recommendation, a remodeling recommendation, a safety improvement recommendation, an aesthetic home improvement recommendation, etc.) based on, at least, the generated home recommendation model. In a further aspect, once the one or more home recommendations are identified, then the modeling computing device may transmit to the mobile computing device, instructions that cause the mobile computing device to display (e.g., via the user interface of the mobile computing device), a graphical indication of the one or more home recommendations. Other examples are possible.

### II. Example Architecture and Operations

### A. Computing Device

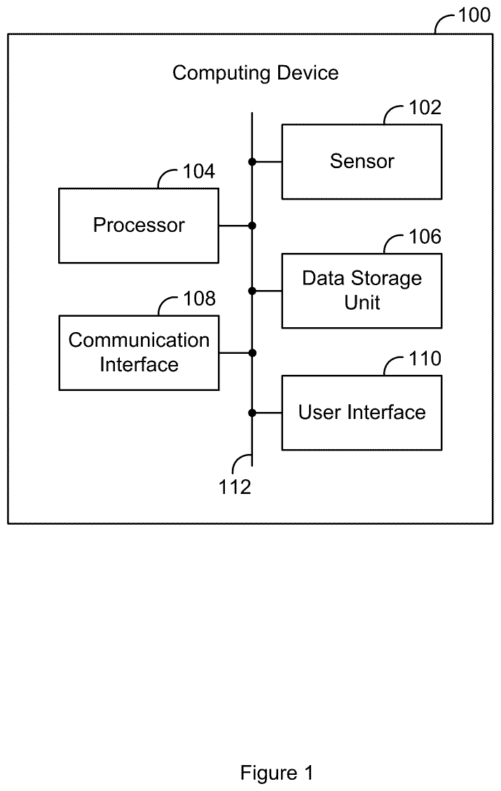

FIG. 1 is a simplified block diagram of an example computing device 100. The computing device 100 can be configured to perform and/or can perform one or more acts and/or functions, such as those described in this disclosure. The computing device 100 can include various components, such as a sensor 102, a processor 104, a data storage unit 106, a communication interface 108, and/or a user interface 110. Each of these components can be connected to each other via a connection mechanism 112.

In this disclosure, the term “connection mechanism” means a mechanism that facilitates communication between two or more components, devices, systems, or other entities. A connection mechanism can be a relatively simple mechanism, such as a cable or system bus, or a relatively complex mechanism, such as a packet-based communication network (e.g., the Internet). In some instances, a connection mechanism can include a non-tangible medium (e.g., in the case where the connection is wireless).

The sensor 102 can include sensors now known or later developed, including but not limited to accelerometer sensors, a sound detection sensor, a motion sensor, a humidity sensor, a temperature sensor, a proximity sensor (e.g., a Bluetooth sensor and/or communication protocol to determine the proximity of a mobile computing device to one or more portions and/or features of a home), a location sensor (e.g., a GPS sensor), time sensors (e.g., a digital clock), camera sensors (e.g., cameras on a mobile computing device), device interaction sensors (e.g., a touch screen and/or retinal scanner on a mobile computing device, such as a smartphone), and/or a combination of these sensors, among other possibilities.

The processor 104 can include a general-purpose processor (e.g., a microprocessor) and/or a special-purpose processor (e.g., a digital signal processor (DSP)). The processor 104 can execute program instructions included in the data storage unit 106 as discussed below.

The data storage unit 106 can include one or more volatile, non-volatile, removable, and/or non-removable storage components, such as magnetic, optical, and/or flash storage, and/or can be integrated in whole or in part with the processor 104. Further, the data storage unit 106 can take the form of a non-transitory computer-readable storage medium, having stored thereon program instructions (e.g., compiled or non-compiled program logic and/or machine code) that, upon execution by the processor 104, cause the computing device 100 to perform one or more acts and/or functions, such as those described in this disclosure. These program instructions can define, and/or be part of, a discrete software application. In some instances, the computing device 100 can execute program instructions in response to receiving an input, such as an input received via the communication interface 108 and/or the user interface 110. The data storage unit 106 can also store other types of data, such as those types described in this disclosure.

The communication interface 108 can allow the computing device 100 to connect with and/or communicate with another entity, such as another computing device, according to one or more protocols. In one example, the communication interface 108 can be a wired interface, such as an Ethernet interface. In another example, the communication interface 108 can be a wireless interface, such as a cellular or WI-FI interface. In this disclosure, a connection can be a direct connection or an indirect connection, the latter being a connection that passes through and/or traverses one or more entities, such as a router, switch, or other network device. Likewise, in this disclosure, a transmission can be a direct transmission or an indirect transmission.

The user interface 110 can include hardware and/or software components that facilitate interaction between the computing device 100 and a user of the computing device 100, if applicable. As such, the user interface 110 can include input components such as a keyboard, a keypad, a mouse, a touch-sensitive panel, and/or a microphone, and/or output components such as a display device (which, for example, can be combined with a touch-sensitive panel), a sound speaker, and/or a haptic feedback system.

The computing device 100 can take various forms, such as a workstation terminal, a desktop computer, a laptop, a tablet, and/or a mobile smartphone. Additionally, as used herein, “mobile computing device” describes computing devices that are highly mobile (including a laptop, a tablet, and/or a mobile phone), as well as computing devices that are not as mobile (including a desktop computer, etc.). In a further aspect, the features described herein may involve some or all of these components arranged in different ways, including additional or fewer components and/or different types of components, among other possibilities.

### B. Home Recommendation Computing System

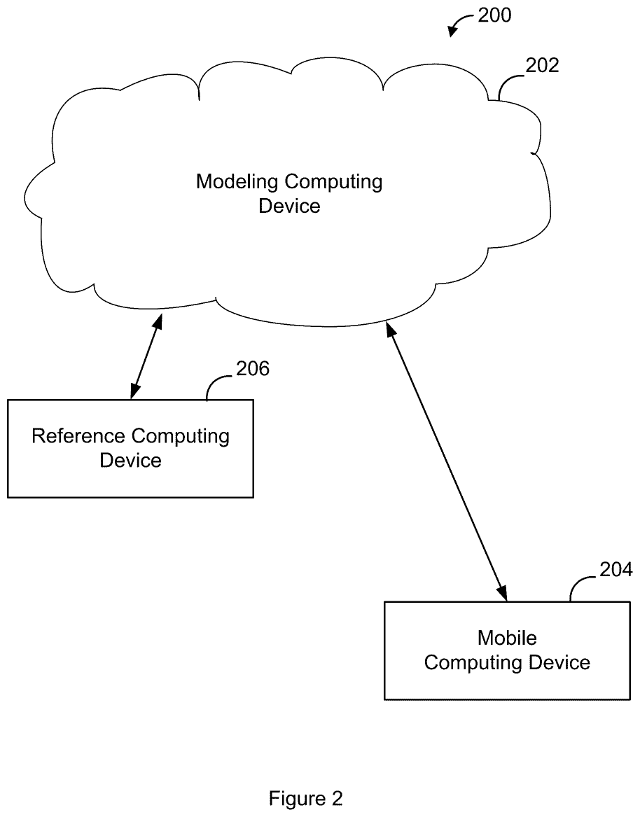

FIG. 2A is an example home recommendation computing system 200.

The home recommendation computing system 200 can perform various acts and/or functions related to video and/or image data of the particular home and/or features or portions thereof, from one or more mobile computing devices, and/or data associated with the particular home to generate a home recommendation model for the particular home and take one or more responsive actions in connection with the particular home, and can be implemented as a computing system. In this disclosure, the term “computing system” means a system that includes at least one computing device, such as computing device 100. In some instances, a computing system can include one or more other computing systems.

It should also be readily understood that computing device 100, home recommendation computing system 200, and any of the components thereof, can be physical systems made up of physical devices, cloud-based systems made up of cloud-based devices that store program logic and/or data of cloud-based applications and/or services (e.g., for performing at least one function of a software application or an application platform for computing systems and devices detailed herein), or some combination of the two.

In accordance with example embodiments, the home recommendation computing system 200 can include various components, such as a modeling computing device 202 (shown here as a cloud-based computing device), a mobile computing device 204, and reference computing device 206, each of which can be implemented as a computing system or part of a computing system. In some examples, the modeling computing device and the mobile computing device are the same computing device. In other examples, the modeling computing device and the mobile computing device are different computing devices.

The home recommendation computing system 200 can also include connection mechanisms (shown here as lines with arrows at each end (i.e., “double arrows”), which connect modeling computing device 202 (shown here as a cloud-based computing device), a mobile computing device 204, and reference computing device 206, and may do so in a number of ways (e.g., a wired mechanism, wireless mechanisms and communication protocols, etc.).

In practice, the home recommendation computing system 200 is likely to include many of some or all of the example components described above, such as the mobile computing device 204, and reference computing device 206.

The home recommendation computing system 200 and/or components thereof can perform various acts and/or functions (many of which are described above). Examples of these and related features will now be described in further detail.

Within home recommendation computing system 200, modeling computing device 202 may collect data from a number of sources.

For example, modeling computing device 202 may collect data from one or more mobile computing devices associated with the particular home, including the mobile computing device 204 in and/or around the particular home. In some examples, this mobile computing device 204 may contain one or more cameras that capture images and/or videos of the particular homes and/or portions thereof. In some examples, a user may use a mobile computing device capture a video of the particular home and upload it one or more resources for further analysis by the home recommendation computing system 200 (e.g., via modeling computing device 202). In some examples, this mobile computing device 204 may belong to a potential purchaser and/or owner of the particular home and/or another party associated with the home, among other possibilities.

For example, this mobile computing device 204 may receive user input in connection with the particular homes and/or portions thereof—including text-based input and/or annotations to one or more images on the mobile computing device 204, among other possibilities.

In one example, modeling computing device 202 may collect data from reference computing device 206 concerning a particular home and/or one or more homes that share one or more attributes with the particular home, and may do so in a number of ways. For example, reference computing device 206 may include one or more of the following: (i) public and/or private databases associated with the particular home and/or one or more homes that share one or more attributes with the particular home; (ii) real estate listings of the particular home and/or one or more homes that share one or more attributes with the particular home; (iii) land records of the particular home and/or one or more homes that share one or more attributes with the particular home; (iv) government databases storing information associated with the particular home and/or one or more homes that share one or more attributes with the particular home; (v) geolocation and/or map databases associated with the particular home and/or one or more homes that share one or more attributes with the particular home; and (vi) other databases that include images, videos, and other data associated with the particular home and/or one or more homes that share one or more attributes with the particular home (e.g., one or more three-dimensional computing models of the particular home).

Once the modeling computing device 202 collects data from mobile computing device 204 and/or reference computing device 206, the modeling computing device 202 may generate one or more home recommendation models using one or more machine learning models (e.g., NeRF, SLAM, and/or SfM models, among other possibilities). In example embodiments, these home recommendation models may be constructed using any or all of the data collected from the mobile computing device 204 and/or reference computing device 206, and/or other sources. In some examples, the modeling computing device may analyze the plurality of captured images or video, extracts frames, and processes it into a one or more models (e.g., a NeRF model) to reconstruct the scene in two- or three-dimensional renderings and/or models.

In one example, the modeling computing device 202 may train one one or more models using data associated with one or more images and/or user input associated with a particular home. Furthermore, the home recommendation model may be updated over time based on further data collected from the mobile computing device 204 and/or reference computing device 206, and/or other sources. Additionally, the home recommendation model may be used to update the data sources from which it has collected data (e.g., updating the reference computing device 206 with one or more indications of one or more features of the particular home), as well as data sources from which it may not have collected data.

In a further aspect, in one example, the modeling computing device 202 may identify one or more characteristic of the home based on the captured plurality of images and/or video (e.g., potential damage to the particular home) and take one or more responsive actions. In another example, the modeling computing device 202 may not be able to accurately identify the damage to the particular home based on insufficient data and ask that the user of the mobile computing device 204 retake and/or re-upload the captured plurality of images and/or video to the modeling computing device 202 for further analysis. In response, the modeling computing device 202 may transmit one or more instructions (e.g., to the mobile computing device 204) to correct the insufficient data. In one example, the modeling computing device 202 may transmit one or more instructions to the mobile computing device 204 that captured the plurality of images of the home to capture additional and/or alternative images, and may provide instructions to a user of the mobile computing device 204 on how to do so. In this regard, modeling computing device 202 can send suggestion prompts and updated suggestion prompts to the mobile computing device 204 to further facilitate the generation and regeneration of the home recommendation models and/or identify associated home recommendations based on the same.

Once the modeling computing device 202 has identified the potential home recommendations associated with the particular home, the modeling computing device 202 may transmit instructions that cause a computing device (e.g., the modeling computing device 202, a mobile computing device 204, or both) to display one or more graphical indications of the potential the potential home recommendations associated with the particular home.

Other computational actions, displayed graphical indications, alerts, and configurations are possible.

### C. Example Mobile Computing Device of the Home Recommendation and Associated Graphical User Interfaces

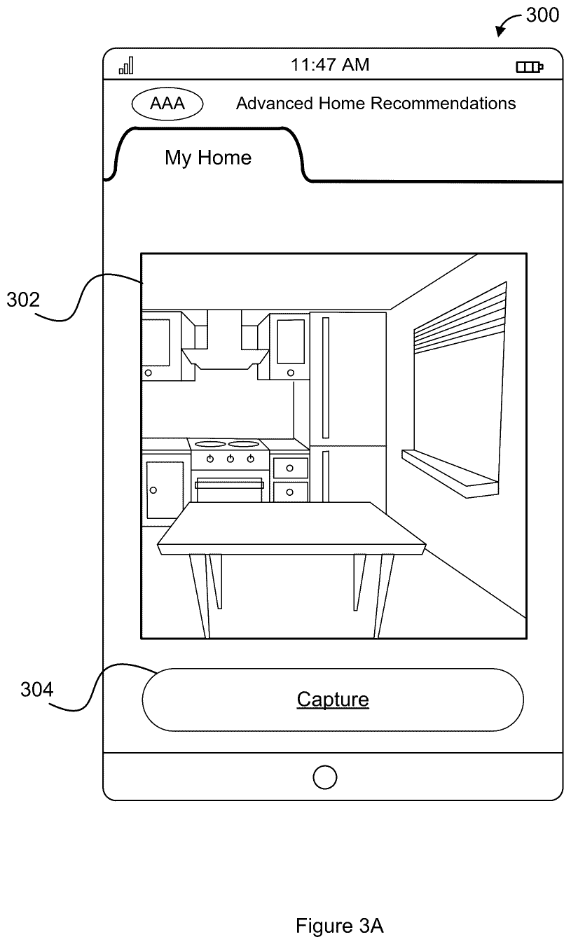

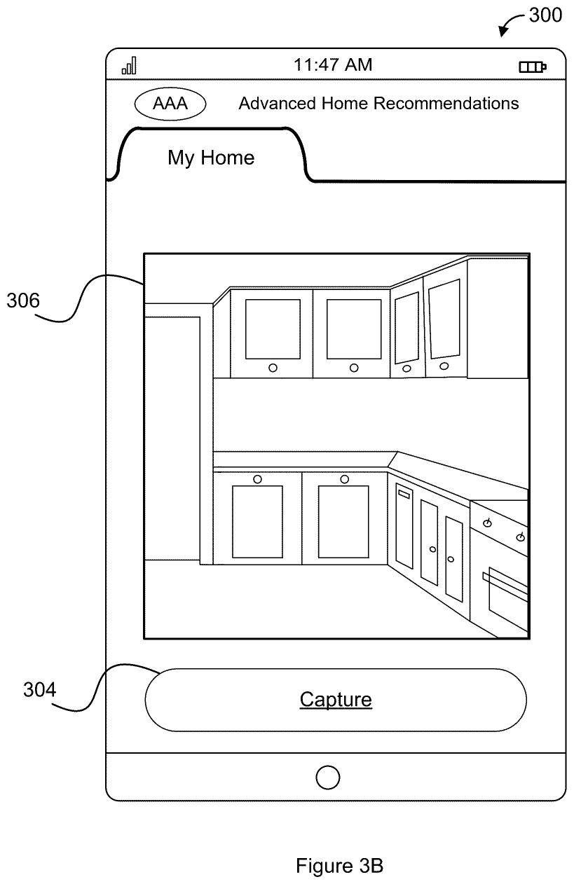

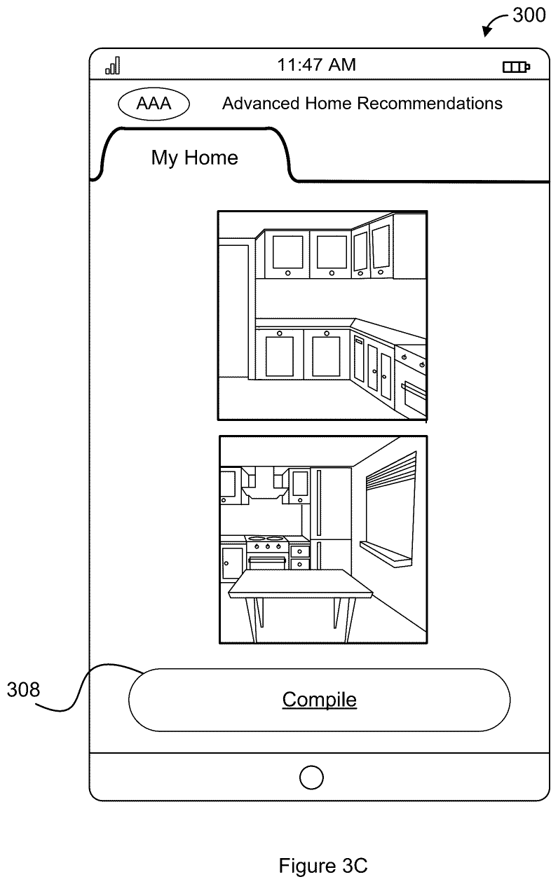

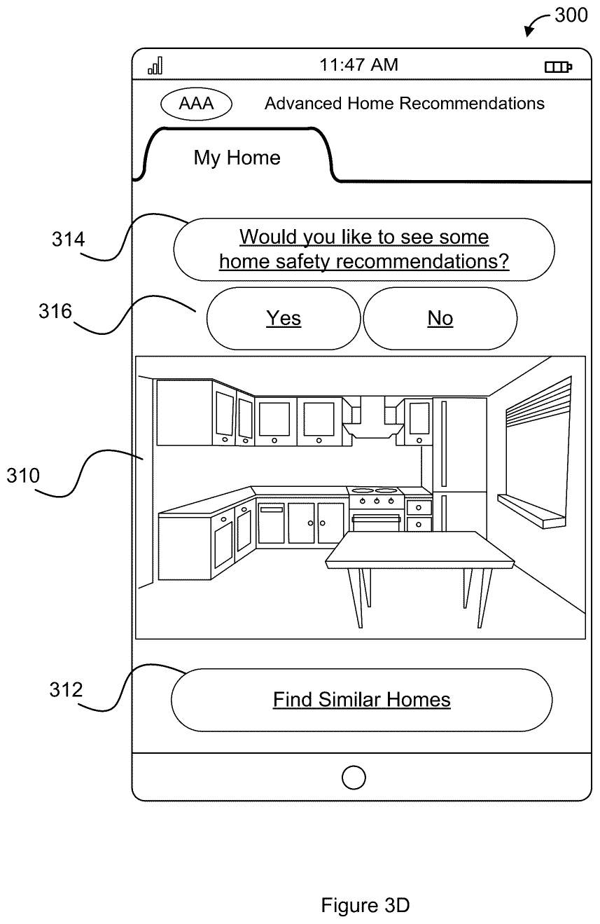

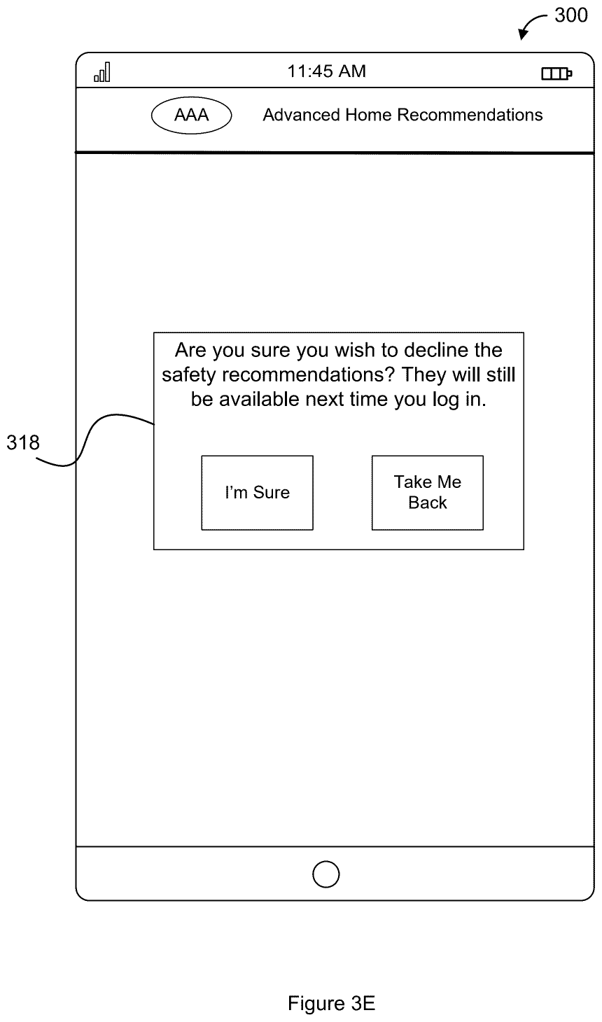

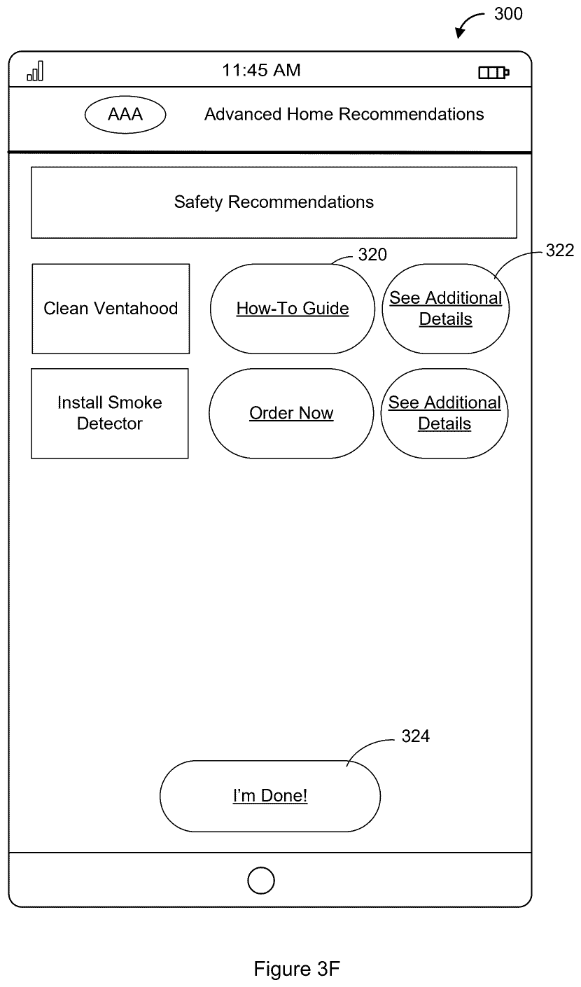

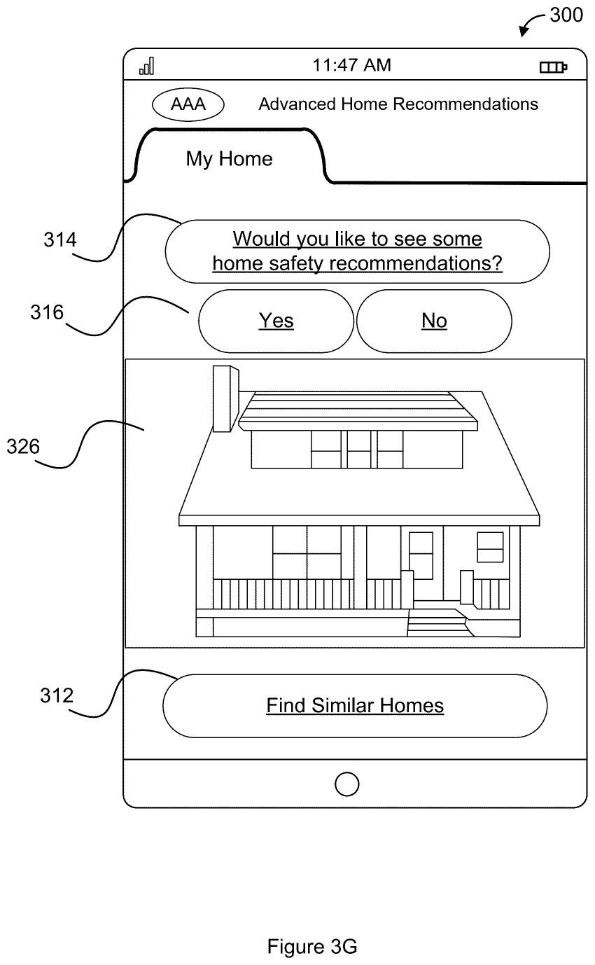

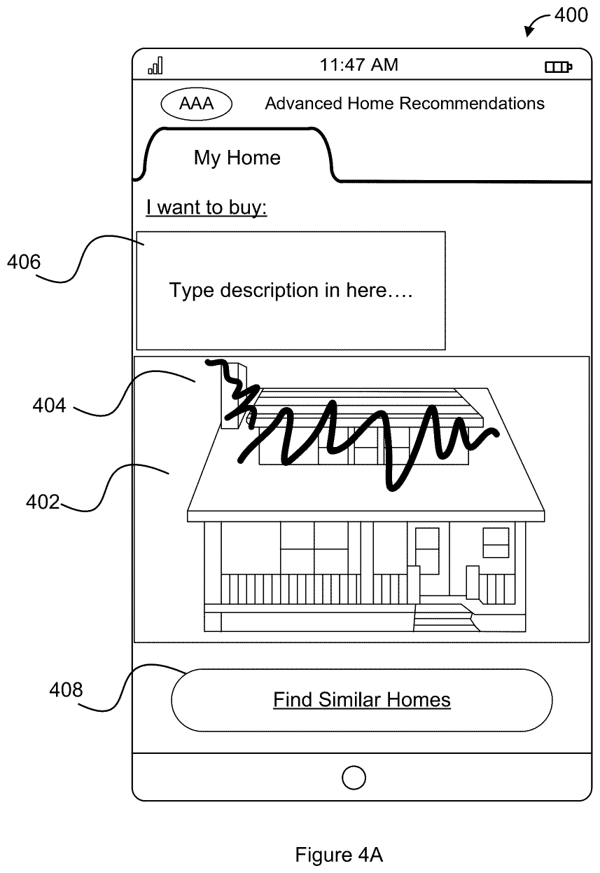

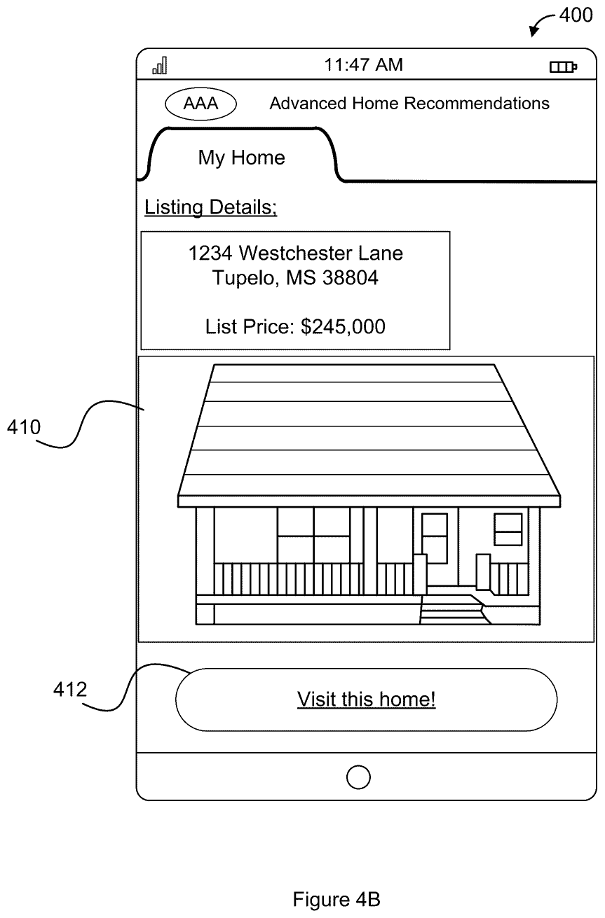

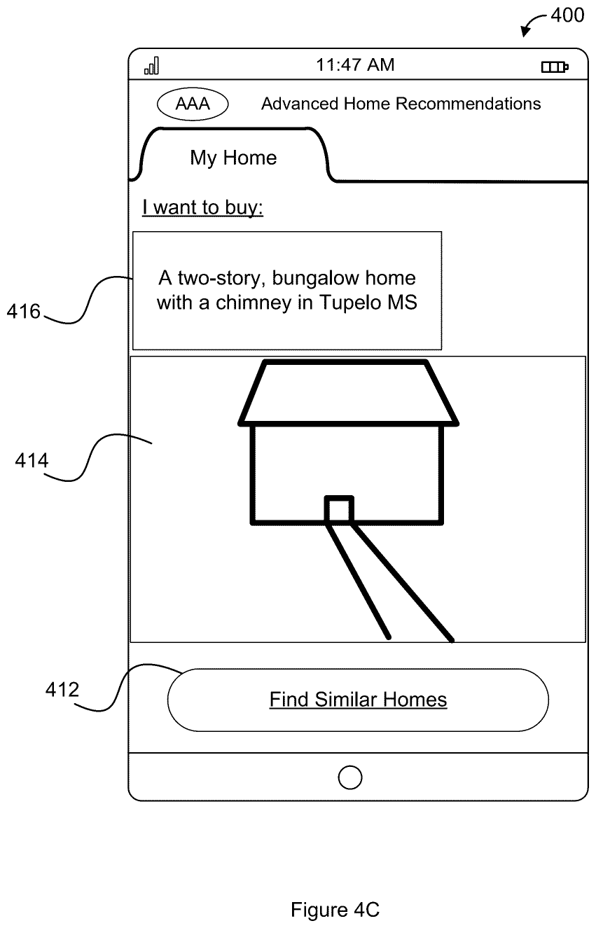

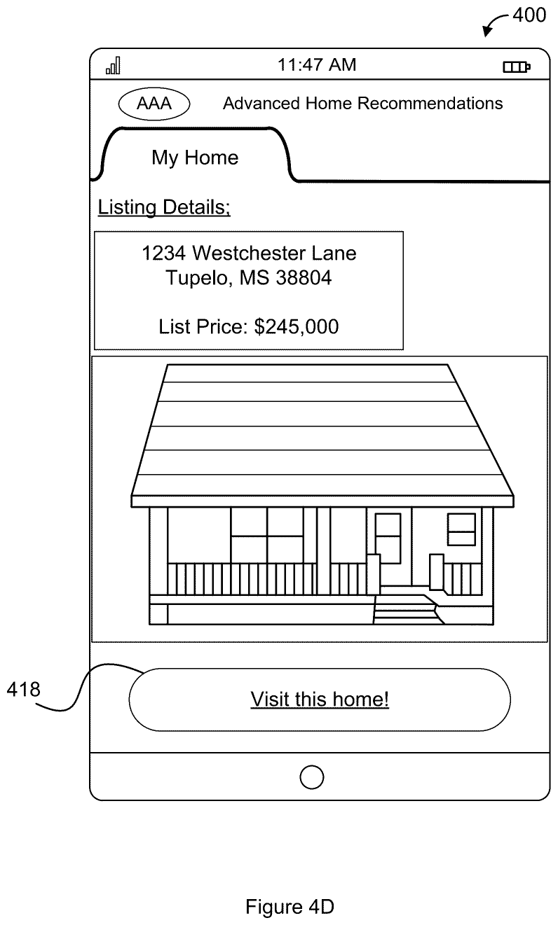

To further illustrate the above-described concepts and others, FIGS. 3A-3B depict a graphical user interface, in accordance with example embodiments. Although illustrated in FIGS. 3A-4D as being displayed via a user interface of a mobile computing device (a smart phone), this graphical user interface may be provided for display by one or more components described in connection with home recommendation computing system 200 (e.g., via a user interface of mobile computing device 204), among other possibilities.

The information displayed by the graphical user interfaces may also be derived, at least in part, from data stored and processed by the components described in connection with home recommendation computing system 200, and/or other computing devices or systems configured to generate such graphical user interfaces and/or receive input from one or more users (e.g., those described in connection with home recommendation computing system 200, as well as the components of FIGS. 1 and 2). In other words, this graphical user interface is merely for the purpose of illustration. The features described herein may involve graphical user interfaces that format information differently, include more or less information, include different types of information, and relate to one another in different ways.

In accordance with an example embodiment, FIGS. 3A-3G depict an example graphical user interface 300 in various states. Graphical user interface 300 includes visual representations that notify the user of a computing device associated with a particular home, the home recommendation computing system, or both that one or more potential areas of improvement and/or recommendations that have been detected in one or more environments of the particular home and presents the user with more dynamic, visual indications of associated improvement and/or recommendations for particular home and/or various suggestion prompts for addressing these environments that may be taken in response to the detected information.

Specifically, in the context of FIG. 3A, FIG. 3A depicts an example graphical user interface 300 illustrated in a first state. In FIG. 3A, graphical user interface 300 displays a first rendering 302 of a first environment of a home, which allows the user of the mobile computing device to view the environment of the home (a kitchen environment) at a first angle and position, and in a non-annotated state before the user captures a first image of the environment, by pressing capture icon 304. Turning to FIG. 3B, graphical user interface 300 displays a second rendering 306 of the environment, a second angle and position of a kitchen environment, which allows the user of the mobile computing device to view the environment of the home in a non-annotated state before the user captures a second image of the second environment, by pressing capture icon 304. Turning to FIG. 3C, graphical user interface 300 displays the captured images of the first and second renderings in a non-annotated state before the user compiles the captured images, by pressing compile icon 308.

In a further aspect, as illustrated in FIG. 3D, graphical user interface 300 displays a modelled rendering 310 of the environment of the home (the kitchen), which allows the user of the mobile computing device to view the particular environment of the home in an annotated state. In example embodiments, the modelled rendering 310 may be generated based on one or more of the models described in further detail above (e.g., NeRF, SLAM, and/or SfM models), as well as other two- and three-dimensional modeling programs, including by supplementing the captured images of the environment using data collected and/or referenced from other sources (e.g., images of the environment that were previously captured—for example in a real estate listing and/or otherwise previously captured and/or uploaded in connection with the environment). As shown in FIG. 3D, one or more responsive actions and/or recommendations may be presented to the used of the mobile computing device based on the modelled rendering 310.

For example, as shown in FIG. 3D, an associated first suggestion prompt 312 (“Find Similar Homes”) is presented to the user of the mobile computing device, which, if engaged by the user may use the home recommendation model (e.g., via modeling computing device 202) to locate one or more real estate listings of homes that share one or more attributes with the modelled rendering 310 (e.g., approximate square footage, color and/or cabinet configurations, appliance configurations, etc.). Further, as shown in FIG. 3D, an associated second suggestion prompt 314 (“Would you like to see some home safety recommendations?”) is also presented to the user of the mobile computing device, which, if engaged by the user may use the home recommendation model (e.g., via modeling computing device 202) to locate one or more recommendations for the environment represented by the modelled rendering 310 (the kitchen environment). In example embodiments, the user may also be presented with decision prompts 316 to determine whether the user is willing to engage with second suggestion prompt 314.

Turning to FIG. 3E, FIG. 3E illustrates that the user has selected to decline the safety recommendations via decision prompts 316 and graphical user interface 300 displays an additional decline prompt 318 to confirm that the user does not want to receive or accept the safety recommendations. In example embodiments, if the user proceeds with declining the safety recommendations (e.g., by selecting “I'm Sure”), then the mobile computing device may transmit an instruction to the home recommendation computing system to create a record associated with a user profile that the safety recommendations generated by the home recommendation computing system were declined by the user—which in turn may affect a number of data records and/or models associated with the user profile (e.g., insurance premiums, future safety recommendations for the user profile, etc.).

Alternatively, turning to FIG. 3F, FIG. 3F illustrates that the user has selected to receive the safety recommendations via decision prompts 316 and graphical user interface 300 displays graphical indications of the two safety recommendations generated by the home recommendation computing system, illustrated in FIG. 3F as “Clean Ventahood” and “Install Smoke Detector”, each of which has an action prompt 320 and an additional information prompt 322. In example embodiments, if the user proceeds with performing the safety recommendations and confirms the same (e.g., going through the steps of the “How-To Guide”, performing a purchasing recommendation by selecting “Order Now”, or selecting confirmation prompt 324), then the mobile computing device may transmit an instruction to the home recommendation computing system to create a record associated with the user profile that the safety recommendations generated by home recommendation computing system were accepted and performed by the user—which in turn may affect a number of data records and/or models associated with the user profile (e.g., insurance premiums, future safety recommendations for the user profile, etc.).

Turning to FIG. 3G, an alternative view of the graphical user interface 300 illustrated in FIG. 3D is illustrated in which a graphical user interface 300 displays an alternative modelled rendering 326 of an alternative environment of the home (the front exterior view), which allows the user of the mobile computing device to view the particular environment of the home in an annotated state. As described above, in example embodiments, the alternative modelled rendering 326 may be generated based on one or more of the models, including by supplementing the captured images of the environment using data collected and/or referenced from other sources (e.g., images of the environment that were previously captured—for example in a real estate listing and/or otherwise previously captured and/or uploaded in connection with the environment). As shown in FIG. 3G, one or more responsive actions and/or recommendations may be presented to the used of the mobile computing device based on the modelled alternative modelled rendering 326, including an associated first suggestion prompt 312 (“Find Similar Homes”), which, if engaged by the user may use the home recommendation model to locate one or more real estate listings of homes that share one or more attributes with the modelled rendering 310 (e.g., a chimney, color and/or other exterior feature configurations, etc.). Further, as shown in FIG. 3G, an associated second suggestion prompt 314 (“Would you like to see some home safety recommendations?”) is also presented to the user of the mobile computing device, which, if engaged by the user may use the home recommendation model (e.g., via modeling computing device 202) to locate one or more recommendations for the environment represented by the modelled rendering 310 (the exterior environment), as well as decision prompts 316 to determine whether the user is willing to engage with second suggestion prompt 314. Other examples are possible.

In accordance with an example embodiment, FIGS. 4A-4D depict an example graphical user interface 400 in various states. Graphical user interface 400 includes visual representations that notify the user of a computing device associated with a particular home, the home recommendation computing system, or both that one or more potential areas of purchasing recommendations that have been detected in one or more environments of the particular home and presents the user with more dynamic, visual indications of recommendations for particular home and/or various suggestion prompts for addressing these environments that may be taken in response to the detected information.

Specifically, in the context of FIG. 4A, FIG. 4A depicts an example graphical user interface 400 illustrated in a first state. In FIG. 4A, graphical user interface 400 displays a first rendering 402 of a first environment of a home, which allows the user of the mobile computing device to input an annotation of a captured an image of the environment (shown in FIG. 4A as marking out the features of the home the buyer wants to remove from a search) to create an annotated rendering 404, as well as add any text-based input that informs the analysis and/or training of home recommendation model via text prompt 406. As shown in FIG. 4A, an associated first suggestion prompt 408 (“Find Similar Homes”) is presented to the user of the mobile computing device, which, if engaged by the user may use the home recommendation model (e.g., via modeling computing device 202) to locate one or more real estate listings of homes that share one or more attributes with the annotated rendering 404, as well as supplement the captured images of the environment using data collected and/or referenced from other sources (e.g., images of the environment that were previously captured—for example in a real estate listing and/or otherwise previously captured and/or uploaded in connection with the environment). In some examples, by prompting the home recommendation model via text prompt 406, the home recommendation model is not retrained, but instead regenerates the annotated rendering 404 with guidance provided by the additional prompting of text prompt 406 and/or other prompts and/or annotations from the user of the mobile computing device.

As shown in FIG. 4B, by engaging with the associated first suggestion prompt 408 (“Find Similar Homes”), the user of the mobile computing device is presented by a recommendation by the home recommendation model (e.g., via modeling computing device 202) of a purchasing recommendation of a real estate listing of a home that shares one or more attributes with the annotated rendering 404, but without any of the unwanted features of the home in the captured image (e.g., no chimney or dormers). Further, as shown in FIG. 3D, listing information for the purchasing recommendation is also displayed, as is an associated second suggestion prompt 412 (“Visit this home!”) which, if engaged by the user may use the home recommendation model to provide directions to the home and/or locate one or more recommendations for the environment represented by the annotated rendering 404.

Turning to FIG. 4C, graphical user interface 400 displays a crude annotation rendering 414 of a home that a user of the mobile computing device has inputted to illustrate features of a home that the buyer wants to include from a search to create a purchasing recommendation, as well as added text-based input via text prompt 416, both of which inform the training, analysis, and ultimately the recommendation of the home recommendation model. As shown in FIG. 4C, an associated first suggestion prompt 412 (“Find Similar Homes”) is presented to the user of the mobile computing device, which, if engaged by the user may use the home recommendation model (e.g., via modeling computing device 202) to locate one or more real estate listings of homes that share one or more attributes with the crude annotation rendering 414, as well as supplement the captured images of the environment using data collected and/or referenced from other sources—including the text-based input that might be used to generate other text-based content for homes that match the user input via graphical user interface 400 (e.g., in a real estate listing and/or otherwise previously captured and/or uploaded in connection with potential home purchasing searches).

As shown in FIG. 4D, by engaging with the associated first suggestion prompt 408 (“Find Similar Homes”), the user of the mobile computing device is presented by a recommendation by the home recommendation model (e.g., via modeling computing device 202) of a purchasing recommendation of a real estate listing of a home that shares one or more attributes with the crude annotation rendering 414 and the features of the home in the text-based input of the text prompt 416 (e.g., “A two-story, bungalow home with a chimney in Tupelo MS”). Further, as shown in FIG. 4D, listing information for the purchasing recommendation is also displayed, as is an associated second suggestion prompt 418 (“Visit this home!”) which, if engaged by the user may use the home recommendation model to provide directions to the home and/or locate one or more recommendations for the environment represented by crude annotation rendering 414 and the features of the home in the text-based input of the text prompt 416. Other examples are possible.

For example, in some example embodiments, the user of the graphical user interfaces 300 and/or 400 may interact with the annotations for a variety of purposes. For example, after the annotations are provided via graphical user interfaces 300 and/or 400, the user may further annotate potential areas of interest associated with one or more environments of a home and request further information and/or recommendations, as well as supplement existing annotations with other data (e.g., further descriptive information for the home). In some examples, such prompts and/or annotations are transmitted to the home recommendation model and the home recommendation model is not retrained, but instead regenerates the annotated renderings with guidance provided by the additional prompting and/or annotations from the user of the mobile computing device. Other examples are possible

Further, as described in further detail above, the graphical indications in FIGS. 3A-4D may vary in real time based, for example, on updated resource data (e.g., from the mobile computing device and/or reference computing devices) and/or recursively regenerated home recommendation models for one or more homes and/or associated user devices, among other possibilities. Other examples and/or additional information and prompts for display via graphical user interface 300 are possible.

These example graphical user interfaces are merely for purposes of illustration. The features described herein may involve graphical user interfaces that are configured or formatted differently, include more or less information and/or additional or fewer instructions, include different types of information and/or instructions, and relate to one another in different ways.

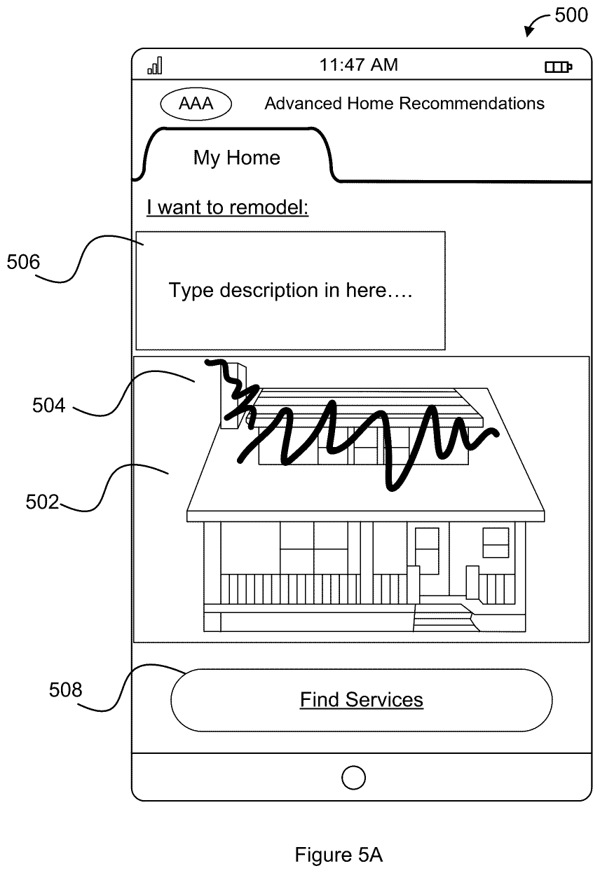

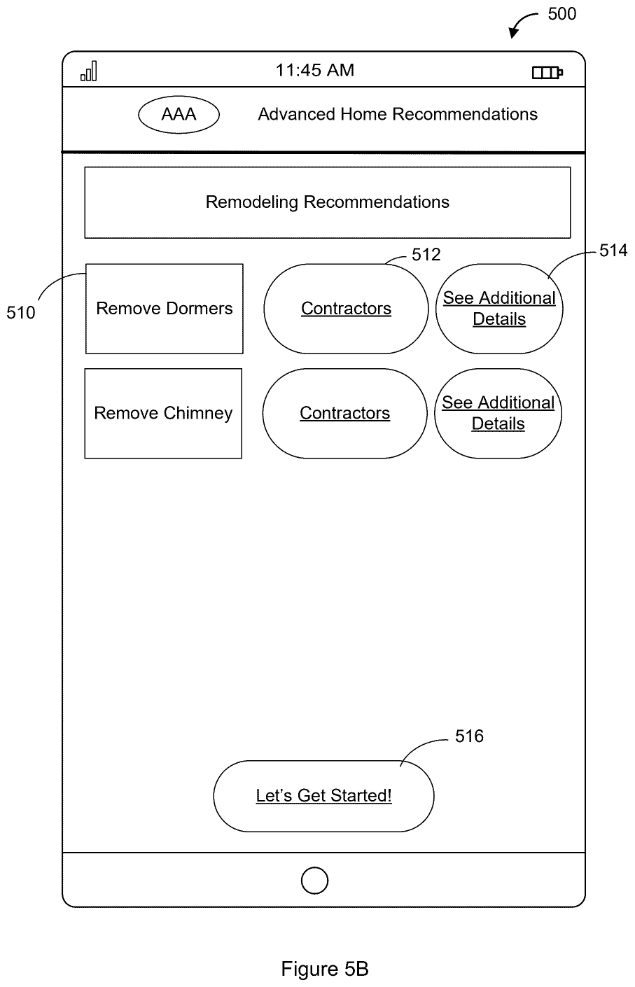

In accordance with an example embodiment, FIGS. 5A-5B depict an example graphical user interface 500 in various states. Graphical user interface 500 includes visual representations that notify the user of a computing device associated with a particular home, the home recommendation computing system, or both that one or more potential areas of remodeling recommendations that have been detected in one or more environments of the particular home and presents the user with more dynamic, visual indications of recommendations for particular home and/or various suggestion prompts for addressing these environments that may be taken in response to the detected information.

Specifically, in the context of FIG. 5A, FIG. 5A depicts an example graphical user interface 500 illustrated in a first state. In FIG. 5A, graphical user interface 500 displays a rendering 502 of a first environment of a home, which allows the user of the mobile computing device to input an annotation of a captured an image of the environment (shown in FIG. 5A as marking out the features of the home the remodeler wants to remove from a home) to create an annotated rendering 504, as well as add any text-based input that informs the analysis and/or training of home recommendation model via text prompt 506. As shown in FIG. 5A, an associated first suggestion prompt 508 (“Find Services”) is presented to the user of the mobile computing device, which, if engaged by the user may use the home recommendation model (e.g., via modeling computing device 202) to locate one or more services (e.g., general contractors, home-improvement suppliers, etc. that offer and/or otherwise share one or more attributes with the annotated rendering 504, as well as supplement the captured images of the environment and/or environments that share attributes with the annotated image, potentially using data collected and/or referenced from other sources (e.g., images of the environment that were previously captured—for example in a real estate listing and/or otherwise previously captured and/or uploaded in connection with the environment and/or similar environments). In some examples, by prompting the home recommendation model via text prompt 506, the home recommendation model is not retrained, but instead regenerates the annotated rendering 504 with guidance provided by the additional prompting of text prompt 506 and/or other prompts and/or annotations from the user of the mobile computing device. Other examples are possible.

As shown in FIG. 5B, by engaging with the associated first suggestion prompt 508 (“Find Services”), the user of the mobile computing device is presented by a recommendation by the home recommendation model (e.g., via modeling computing device 202) of remodeling recommendations and graphical user interface 500 displays graphical indications of the two remodeling recommendations generated by the home recommendation computing system, illustrated in FIG. 5B as “Remove Dormers” and “Remove Chimney”, each of which has an action prompt 512 and an additional information prompt 514. In example embodiments, if the user proceeds with performing the remodeling recommendations and confirms the same (e.g., going through the steps of selecting one or more contractors via action prompt 512, performing a purchasing recommendation, or selecting confirmation prompt 516), then the mobile computing device may transmit an instruction to the home recommendation computing system to provide additional information and/or instructions in connection with the associated remodeling project (e.g., information associated with the contractor, one or more specific bids for undertaking the remodeling efforts, and/or create a record associated with the user profile that the remodeling recommendations generated by home recommendation computing system were accepted and performed by the user). In a further aspect, some or all of these actions may also be used by the home recommendation computing system to update one or more data records and/or models associated with the user profile (e.g., insurance premiums, future remodeling recommendations for the user profile, etc.). Other examples are possible.

### D. Example Method

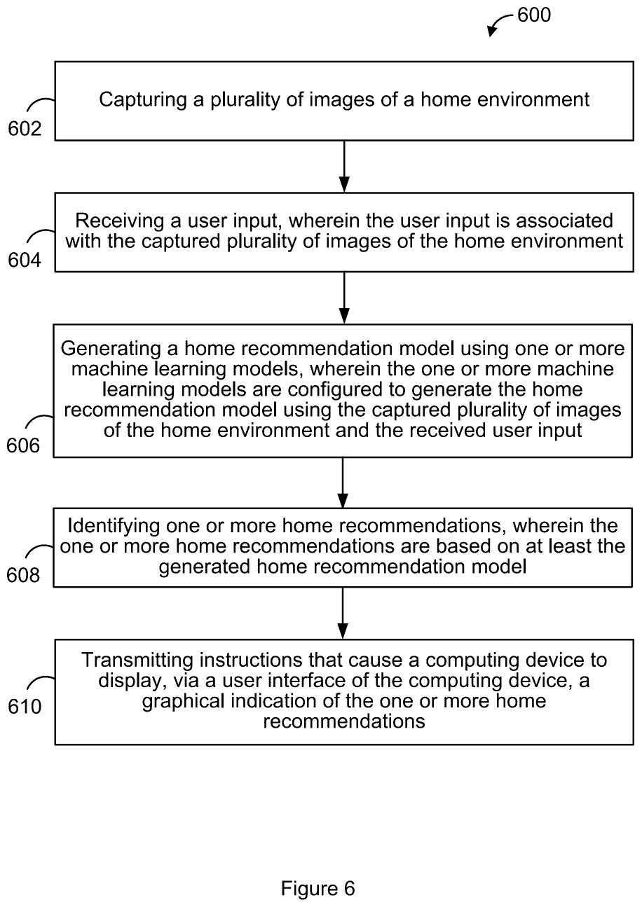

FIG. 6 is a flow chart illustrating an example method 600.

At block 602, the method 600 can include, capturing a plurality of images of a home environment. In some examples, the plurality of images comprises at least two images, and wherein each image is captured from a different angle by the camera of the mobile computing device in relation to the home environment. In other examples, the plurality of images comprises a video, and wherein the video is captured by the camera of the mobile computing device, and wherein an angle of the camera in relation to the home environment varies over a length of the captured video.

At block 604, the method 600 can include, receiving a user input, wherein the user input is associated with the captured plurality of images of the home environment. In some examples, the received user input is a text-based input associated with the captured plurality of images. In some examples, the received user input comprises an annotation associated with the captured plurality of images. In some examples, the annotation associated with the captured plurality of images comprises an annotation of the received plurality of images via the user interface of the mobile computing device.

At block 606, the method 600 can include, generating a home recommendation model using one or more machine learning models, wherein the one or more machine learning models are configured to generate the home recommendation model using the captured plurality of images of the home environment and the received user input. In some examples, the one or more machine learning models comprises a neural radiance fields machine learning model. In other examples, the one or more machine learning models comprises a structure-from-motion machine learning model. In still other examples, the one or more machine learning models comprises a simultaneous localization and mapping machine learning model. In some examples, generating the home recommendation model using one or more machine learning models further comprises, prior to receiving the captured plurality of images of the home environment and the received user input from the mobile computing device, training the one or more machine learning models using a plurality of images associated with one or more attributes of the home environment. In some examples, the home recommendation model is generated by comparing the received plurality of images to the plurality of images associated with one or more attributes of the home environment. In some examples, generating the home recommendation model using one or more machine learning models further comprises, prior to receiving the captured plurality of images of the home environment and the received user input from the mobile computing device, training the one or more machine learning models using a plurality of previously captured images of the home environment. In some examples, the home recommendation model is generated by comparing the received plurality of images to the previously captured plurality of images of the home environment.

At block 608, the method 600 can also include, identifying one or more home recommendations, wherein the one or more home recommendations are based on at least the generated home recommendation model. In some examples, the one or more home recommendations comprises a safety recommendation. In some examples, the safety recommendation comprises a recommendation for improving safety of one or more features of the home environment. In some examples, the one or more home recommendations comprises a purchasing recommendation. In some examples, the one or more home recommendations comprises a remodeling recommendation.

At block 610, the method 600 can also include, transmitting instructions that cause a computing device to display, via a user interface of the computing device, a graphical indication of the one or more home recommendations.

In some examples, the mobile computing device and the modeling computing device and are a same computing device. In some examples, the mobile computing device and the modeling computing device and are different computing devices.

### III. Example Variations

Although some of the acts and/or functions described in this disclosure have been described as being performed by a particular entity, the acts and/or functions can be performed by any entity, such as those entities described in this disclosure. Further, although the acts and/or functions have been recited in a particular order, the acts and/or functions need not be performed in the order recited. However, in some instances, it can be desired to perform the acts and/or functions in the order recited. Further, each of the acts and/or functions can be performed responsive to one or more of the other acts and/or functions. Also, not all of the acts and/or functions need to be performed to achieve one or more of the benefits provided by this disclosure, and therefore not all of the acts and/or functions are required.

Although certain variations have been discussed in connection with one or more examples of this disclosure, these variations can also be applied to all of the other examples of this disclosure as well.

Although select examples of this disclosure have been described, alterations and permutations of these examples will be apparent to those of ordinary skill in the art. Other changes, substitutions, and/or alterations are also possible without departing from the invention in its broader aspects as set forth in the following claims.

We claim:

1. A system for generating home recommendations, wherein the system comprises:
a mobile computing device, wherein the mobile computing device comprises a camera, a user interface, one or more processors, and a non-transitory computer-readable medium, having stored thereon program instructions that, upon execution by the one or more processors, cause the mobile computing device to perform a set of operations comprising:
capturing, via the camera of the mobile computing device, a plurality of images of a home environment; and
receiving, via the user interface of the mobile computing device, a user input, wherein the user input is associated with the captured plurality of images of the home environment; and
a modeling computing device, wherein the modeling computing device comprises one or more processors and a non-transitory computer-readable medium, having stored thereon program instructions that, upon execution by the processor, cause the modeling computing device to perform a set of operations comprising:
receiving, from the mobile computing device, the captured plurality of images of the home environment and the received user input;
generating a home recommendation model using one or more machine learning models, wherein the one or more machine learning models are configured to generate the home recommendation model using the captured plurality of images of the home environment and the received user input;
identifying one or more home recommendations, wherein the one or more home recommendations are based on at least the generated home recommendation model; and
transmitting, to the mobile computing device, instructions that cause the mobile computing device to display, via the user interface of the mobile computing device, a graphical indication of the one or more home recommendations.

2. The system of claim 1, wherein the plurality of images comprises at least two images, and wherein each image is captured from a different angle by the camera of the mobile computing device in relation to the home environment.

3. The system of claim 1, wherein the plurality of images comprises a video, and wherein the video is captured by the camera of the mobile computing device, and wherein an angle of the camera in relation to the home environment varies over a length of the captured video.

4. The system of claim 1, wherein the received user input comprises a text-based input associated with the received plurality of image.

5. The system of claim 1, wherein the received user input comprises an annotation associated with the received plurality of images.

6. The system of claim 5, wherein the annotation associated with the captured plurality of images comprises an annotation of the received plurality of images via the user interface of the mobile computing device.

7. The system of claim 1, wherein the one or more machine learning models comprises a neural radiance fields machine learning model.

8. The system of claim 1, wherein the one or more machine learning models comprises a structure-from-motion machine learning model.

9. The system of claim 1, wherein the one or more machine learning models comprises a simultaneous localization and mapping machine learning model.

10. The system of claim 1, wherein generating the home recommendation model using one or more machine learning models further comprises, prior to receiving the captured plurality of images of the home environment and the received user input from the mobile computing device, training the one or more machine learning models using a plurality of images associated with one or more attributes of the home environment.

11. The system of claim 10, wherein the home recommendation model is generated by comparing the received plurality of images to the plurality of images associated with one or more attributes of the home environment.

12. The system of claim 1, wherein generating the home recommendation model using one or more machine learning models further comprises, prior to receiving the captured plurality of images of the home environment and the received user input from the mobile computing device, training the one or more machine learning models using a plurality of previously captured images of the home environment.

13. The system of claim 12, wherein the home recommendation model is generated by comparing the received plurality of images to the previously captured plurality of images of the home environment.

14. The system of claim 1, wherein the one or more home recommendations comprises a safety recommendation for improving safety of one or more features of the home environment.

15. The system of claim 1, wherein the one or more home recommendations comprises a remodeling recommendation.

16. The system of claim 1, wherein the one or more home recommendations comprises a purchasing recommendation.

17. The system of claim 1, wherein the mobile computing device and the modeling computing device and are a same computing device.

18. The system of claim 1, wherein the mobile computing device and the modeling computing device and are different computing devices.

19. A non-transitory computer-readable medium, having stored thereon program instructions that, upon execution by one or more processors, cause a computing system to perform a set of operations comprising:
capturing a plurality of images of a home environment;
receiving a user input, wherein the user input is associated with the captured plurality of images of the home environment;
generating a home recommendation model using one or more machine learning models, wherein the one or more machine learning models are configured to generate the home recommendation model using the captured plurality of images of the home environment and the received user input;
identifying one or more home recommendations, wherein the one or more home recommendations are based on at least the generated home recommendation model; and
transmitting instructions that cause a computing device to display, via a user interface of the computing device, a graphical indication of the one or more home recommendations.

20. A method comprising:
capturing a plurality of images of a home environment;
receiving a user input, wherein the user input is associated with the captured plurality of images of the home environment;
generating a home recommendation model using one or more machine learning models, wherein the one or more machine learning models are configured to generate the home recommendation model using the captured plurality of images of the home environment and the received user input;
identifying one or more home recommendations, wherein the one or more home recommendations are based on at least the generated home recommendation model; and
transmitting instructions that cause a computing device to display, via a user interface of the computing device, a graphical indication of the one or more home recommendations.
